(19) United States
(12) Patent Application Publication
(10) Pub. No.: US 2018/0324655 A1
(43) Pub. Date: Nov. 8, 2018

(54) METHOD OF IDENTIFYING TRAFFIC TO 3GPP RAN HANDED OVER FROM WLAN TO 3GPP RAN

(71) Applicant: Kyocera Corporation, Kyoto (JP)

(72) Inventor: David COMSTOCK, San Diego, CA (US)

(21) Appl. No.: 15/772,235

(22) PCT Filed: Nov. 3, 2016
(86) PCT No.: PCT/US2016/060363

§ 371 Date: Apr. 30, 2018

Related U.S. Application Data
(60) Provisional application No. 62/252,273, filed on Nov. 6, 2015.

(51) Int. Cl. H04W 36/00; H04W 76/15; H04W 36/22; H04W 36/30

(52) U.S. Cl. CPC H04W 36/0066; H04W 76/15; H04W 84/12; H04W 36/22; H04W 36/30; H04W 36/0022

(57) ABSTRACT

In the systems and methods described herein, the 3GPP RAN determines the thresholds that will be provided to the UE devices to facilitate steering traffic between radio networks. More specifically, an eNB of the 3GPP RAN determines the network-related parameter threshold values based, at least partially, on an indication that all or a portion of user data traffic of one or more UE devices is to be handed over from another network (e.g., WLAN). For example, based on the indication that all or a portion of user data traffic of one or more UE devices is to be handed over from another network, the eNB may determine that either more or less traffic should be offloaded to the WLAN. The eNB can modify the network-related parameter threshold values that are being sent to the one or more UE devices so that the level of traffic being offloaded can be appropriately increased or decreased.

### CLAIM OF PRIORITY

The present application claims priority to Provisional Application No. 62/252,273 entitled “METHOD OF IDENTIFYING TRAFFIC TO 3GPP RAN HANDED OVER FROM WLAN TO 3GPP RAN,” docket number TPRO 00275, filed Nov. 6, 2015, which is assigned to the assignee hereof and hereby expressly incorporated by reference in its entirety.

### FIELD

This invention generally relates to traffic steering between two or more networks and more particularly to providing information to at least one of the networks to facilitate the traffic steering process.

### BACKGROUND

Many wireless communication systems use base stations or access points to provide geographical service areas where wireless communication user equipment (UE) devices communicate with the base station or access point providing the particular geographical service area in which the wireless communication UE devices are located. The base stations and access points are connected within a network allowing communication links to be made between the wireless communication UE devices and other devices. In some circumstances, the wireless communication UE devices are capable of communicating on more than one type of network. In these situations, it may be advantageous to obtain data to help inform a decision regarding which network a wireless communication UE device should use to transmit and receive data traffic.

### SUMMARY

In the systems and methods described herein, a first radio network determines one or more network-related parameter thresholds that will be provided to the user equipment (UE) devices. More specifically, a base station of the first radio network determines the network-related parameter threshold values based, at least partially, on an indication that user data traffic of one or more UE devices has been handed over from a second radio network. For example, based on the indication that all or a portion of user data traffic of a UE device is being handed over from the second radio network, the base station may determine that more traffic should be offloaded to the second radio network. The base station can modify the network-related parameter threshold values that are being sent to the one or more UE devices so that more traffic is offloaded. Similarly, the base station may determine that less traffic should be offloaded to the second radio network, based on the indication that all or a portion of user data traffic of a UE device is being handed over from the second radio network. In this case, the base station can modify the network-related parameter threshold values that are being sent to the one or more UE devices so that less traffic is offloaded.

### BRIEF DESCRIPTION OF THE DRAWINGS

FIG. 1 is a block diagram of an example of a system in which a base station of a first radio network receives an indication that user data traffic of a user equipment device is to be handed over from a second radio network and utilizes the indication to affect traffic steering decisions between the first and second radio networks.

FIG. 2 is a block diagram of an example of the base station shown in FIG. 1.

FIG. 3 is a block diagram of an example of the user equipment device shown in FIG. 1.

FIG. 4 is a message diagram for the example where the base station of a first radio network receives an indication that user data traffic of a user equipment device is to be handed over from a second radio network and sets up radio resources for the user data traffic of the user equipment device.

FIG. 5 is a flowchart of an example of a method of utilizing the communication system of FIG. 1 to affect traffic steering between the first and second radio networks.

### DETAILED DESCRIPTION

Due to the increasing demands for wireless bandwidth, mobile network (cellular) operators are interested in offloading data traffic from their mobile networks to other networks that are capable of handling the data traffic from one or more of the mobile wireless communication user equipment devices (UE devices) that are being served by the mobile network. A wireless local area network (WLAN), such as those based on the Institute of Electrical and Electronics Engineers (IEEE) 802.11 specification, is one example of a network that can handle the data traffic from one or more of the UE devices, if certain conditions are met. The offloading of data traffic to the WLAN can help a mobile network from becoming too congested and affecting the level of service that the mobile network can provide to the UE devices being served by the mobile network.

Standards organizations such as 3^{rd} Generation Partnership Project (3GPP) are incorporating procedures in the communications standards to facilitate offloading/onloading traffic between a 3GPP Long-Term Evolution (LTE) Radio Access Network (RAN) and a WLAN. Although the systems and methods disclosed herein refer specifically to offloading/onloading traffic between the 3GPP RAN and a WLAN by providing the base station of a 3GPP RAN with an indication that all or a portion of user data traffic of a UE device is being handed over from another network (e.g., WLAN), it is contemplated that the systems and methods could be modified such that the access point of a WLAN radio network is provided an indication that the UE device has been handed over from the 3GPP RAN. Likewise, the systems and methods disclosed herein could be modified to be used in conjunction with any suitable wireless communication networks other than a 3GPP RAN and a WLAN.

For traffic routing (e.g., steering) UE data traffic between the 3GPP RAN and a WLAN, the 3GPP standard defines thresholds for parameters related to 3GPP RAN and WLAN. These thresholds assist UE devices in making traffic routing decisions (e.g., whether to route data traffic over the 3GPP RAN or over the WLAN). The base station (eNB) of the 3GPP RAN provides the thresholds to UE devices either by broadcast signaling or by unicast signaling. Both low (e.g., minimum) and high (e.g., maximum) thresholds are provided in order to assist the UE devices with network selection in both directions. In the systems and methods described herein, the UE devices make the traffic routing decisions. However, it is contemplated that the traffic routing decisions could be made by any other suitable system entities (e.g., base stations, access points, etc.) that have access to the required parameter threshold information and to the current values of the parameters related to the 3GPP RAN and the WLAN.

The 3GPP RAN-related parameters used to make the traffic routing decisions are radio strength measurements, which include: the UE RSRPₘₑₐₛ (Reference Signal Received Power measurements) and the UE RSRQₘₑₐₛ (Reference Signal Received Quality measurements). The WLAN-related parameters used to make the traffic routing decisions include: a list of WLAN identifiers that may be considered for traffic offloading, UE measurement of the Beacon Received Signal Strength Indicator (WLANRSSI), WLAN Channel Utilization (ChannelUtilizationWLAN), the WLAN backhaul downlink data rate (BackhaulRateDIWLAN), and the WLAN backhaul uplink data rate (BackhaulRateUIWLAN). Current values of each of the 3GPP RAN-related parameters and the WLAN-related parameters may be obtained by the UE by various methods: the UE may measure received signals for various characteristics, the values may be broadcast/unicast from the 3GPP RAN eNB and/or an access point/base station of the WLAN, or the values may be transmitted in response to a query by the UE.

The systems and methods described herein may be modified to utilize various combinations of the different network-related parameters, such combinations also possibly using a greater or lesser number of parameters than the specific example set forth above. For example, other WLAN-related parameters that may be useful in determining appropriate threshold levels may include: Basis Service Set (BSS) Load, UE Average Data Rate, BSS Average Access Delay, and BSS Access Controller Access Delay. Moreover, any other suitable network-related parameters not specifically listed here may be utilized to inform the traffic routing decision.

Once the UE has the parameter threshold values and current values of the 3GPP RAN-related parameters and the WLAN-related parameters, the UE can compare the current parameter values to the threshold values, and under certain conditions, the UE will be triggered to make a traffic routing decision. In making the traffic routing decision, the UE also utilizes a persistence time, t-SteeringWLAN, which specifies a duration of time (e.g., a timer value) during which the conditions should be met before considering traffic steering between the 3GPP RAN and a WLAN. For example, when steering traffic from the 3GPP RAN to the WLAN, Conditions 1 and 2 must both be met for a time interval equal to or greater than the persistence time, t-SteeringWLAN. In order for Condition 1 to be met, either Condition 1a or Condition 1b must be met. In order for Condition 2 to be met, Conditions 2a-2d must all be met.

Condition 1 (3GPP-related parameters)
1a. RSRPₘₑₐₛ < thresholdRSRP-Low; OR
1b. RSRQₘₑₐₛ < thresholdRSRQ-Low
Condition 2 (WLAN-related parameters)
2a. ChannelUtilizationWLAN < thresholdChannelUtilizationLow; AND
2b. BackhaulRateDIWLAN > thresholdBackhaulDL-BandwidthHigh;
AND
2c. BackhaulRateUIWLAN > thresholdBackhaulUL-BandwidthHigh;
AND
2d. WLANRSSI > thresholdWLAN-RSSI-High

When steering traffic from a WLAN to the 3GPP RAN, Condition 3 or Condition 4 must be met for a time interval equal to or greater than the persistence time, t-SteeringWLAN. In order for Condition 3 to be met, Condition 3a and Condition 3b must be met. In order for Condition 4 to be met, at least one of Conditions 4a-4d must be met.

Condition 3 (3GPP-related parameters)
3a. RSRPₘₑₐₛ > thresholdRSRP-High; AND
3b. RSRQₘₑₐₛ > thresholdRSRQ-High
Condition 4 (WLAN-related parameters)
4a. ChannelUtilizationWLAN > thresholdChannelUtilizationHigh; OR
4b. BackhaulRateDIWLAN < thresholdBackhaulDL-BandwidthLow; OR
4c. BackhaulRateUIWLAN < thresholdBackhaulUL-BandwidthLow; OR
4d. WLANRSSI < thresholdWLAN-RSSI-Low

In the systems and methods described herein, the 3GPP RAN determines the thresholds that will be provided to the UE devices. More specifically, an eNB of the 3GPP RAN determines the network-related parameter threshold values based, at least partially, on an indication that user data traffic of one or more UE devices is being handed over from another network (e.g., WLAN). For example, based on the indication from the core network that all or a portion of user data traffic of a UE device is being handed over from another network, the eNB may determine that more traffic should be offloaded to the WLAN. The eNB can modify the network-related parameter threshold values that are being sent to the one or more UE devices so that more traffic is offloaded. Similarly, the eNB may determine that less traffic should be offloaded to the WLAN, based on the indication that user data traffic of one or more UE devices is being handed over from another network (e.g., WLAN). In this case, the eNB can modify the network-related parameter threshold values that are being sent to the one or more UE devices so that less traffic is offloaded.

Alternatively, the systems and methods disclosed herein may be modified so that other entities (e.g., other 3GPP entities, WLAN entities, or the UE devices) may determine, based on the indication that user data traffic of one or more UE devices has been handed over from another network, the thresholds to be used when making traffic routing decisions.

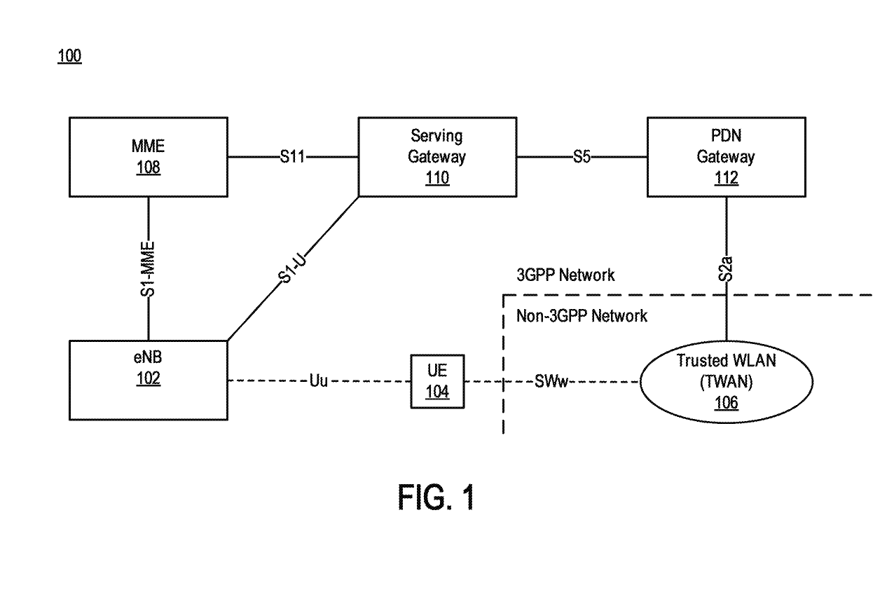

The various functions and operations of the blocks described with reference to the system 100 in FIG. 1 may be implemented in any number of devices, circuits, or elements. Two or more of the functional blocks may be integrated in a single device, and the functions described as performed in any single device may be implemented over several devices. A cellular communication system is typically required to adhere to a communication standard or specification.

The 3GPP LTE communication specification is a specification for systems where base stations (eNBs) provide service to UE devices using orthogonal frequency-division multiplexing (OFDM) on the downlink and single-carrier frequency-division multiple access (SC-FDMA) on the uplink. Although the techniques described herein may be applied in other types of communication systems, the exemplary systems discussed herein operate in accordance with a 3GPP LTE communication specification.

FIG. 1 includes a block diagram of an example of a system 100 in which a base station (eNB) 102 of a first radio network (3GPP RAN) receives an indication that user data traffic of a user equipment device (UE) device 104 has been handed over from a second radio network, Trusted WLAN (TWAN) 106, and utilizes the indication to affect traffic steering decisions between the first and second radio networks. More specifically, FIG. 1 shows a Network Reference Diagram that shows network functions and reference points for a 3GPP RAN interworking with a WLAN. For simplicity, only a selection of the network functions and reference points are shown in FIG. 1. Furthermore, the dashed lines connecting UE device 104 to eNB 102 and TWAN 106 are merely intended to indicate that UE device 104 can be served by either eNB 102 or TWAN 106.

Base station (eNB) 102 provides wireless service to UE device 104 via reference point Uu. Although not explicitly shown in FIG. 1, eNB 102 has a geographical service area in which eNB 102 can provide service to UE device 104. The system 100 also includes TWAN 106 that provides wireless service to UE device 104 via reference point SWw. Although not explicitly shown in FIG. 1, TWAN 106 has a geographical service area in which TWAN 106 can provide service to UE device 104. The respective geographical service areas of eNB 102 and TWAN 106 may partially or fully overlap, may be adjacent to one another, or may not touch each other at all.

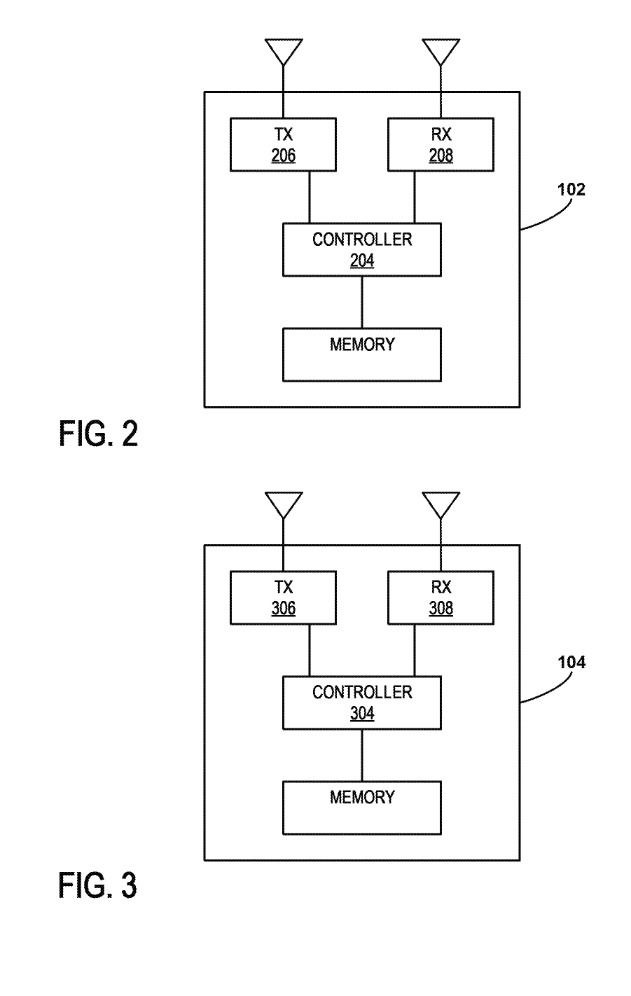

The base station 102 is a fixed transceiver station, sometimes referred to as an eNodeB or eNB. FIG. 2 is a block diagram of an example of the base station 102 shown in FIG. 1. For example, base station 102 includes a controller 204, which is configured to perform the various steps and functions disclosed herein in conjunction with the other components of base station 102.

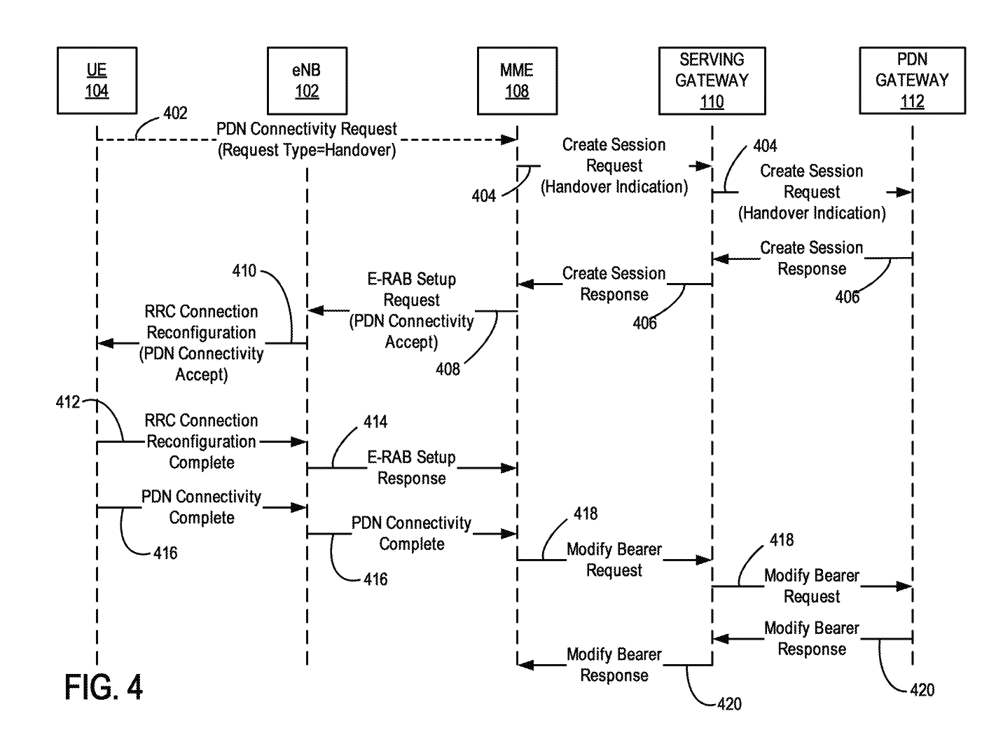

The base station 102 additionally includes a wireless receiver 208 configured to receive wireless signals from UE device 104. Although not shown, base station 102 also comprises a wired interface capable of communicating with the 3GPP Core Network (e.g., a Mobility Management Entity and a Serving Gateway) via a backhaul. The base station is further configured to receive a setup request message (e.g., FIG. 4, reference character 408) requesting that the base station 102 set up radio resources for a user equipment (UE) device 104 for user data traffic being handed over from another network. In an embodiment, the setup request message contains an indication that the radio resources being set up for UE device 104 are to serve user data traffic that are being handed over from a second radio network (e.g., TWAN 106). In the example shown in FIG. 1, the first radio network is a 3GPP Radio Access Network, the second radio network is a WLAN, the setup request message is received from a Mobility Management Entity, and the indication that radio resources being set up for the UE device 104 are to serve user data traffic that are being handed over from a second radio network, is based at least partially on a Request Type parameter received from the UE device in a Connectivity Request message.

The base station 102 additionally includes a wireless transmitter 206 configured to transmit wireless signals to UE device 104. The wireless transmitter 206 is further configured to transmit a control message (e.g., FIG. 4, reference character 410) establishing the requested radio resources. Although FIG. 2 depicts base station 102 as having a separate transmitter 206 and receiver 208, a transceiver could be used in place of transmitter 206 and receiver 208. Similarly, although transmitter 206 and receiver 208 are shown as both having their own antenna, base station 102 may be modified to have different antenna configurations that include a greater number or a smaller number of antennas that may be used to transmit and/or receive wireless signals.

Regardless of the exact configuration of base station 102, transmissions from the base station 102 and from the UE device 104 are governed by a communication specification that defines signaling, protocols, and parameters of the transmission. The communication specification may provide strict rules for communication and may also provide general requirements where specific implementations may vary while still adhering to the communication specification. Although the discussion below is directed to the 3GPP Long Term Evolution (LTE) communication specification, other communication specifications may be used in some circumstances. The communication specification defines at least a data channel and a control channel for uplink and downlink transmissions and specifies at least some timing and frequency parameters for physical downlink control channels from a base station to a wireless communication device.

The wireless UE device 104 may be referred to as a mobile device, a wireless device, a wireless communication device, a mobile wireless device, a mobile wireless communication device, a UE, a UE device, as well as by other terms. FIG. 3 is a block diagram of an example of the UE device 104 shown in FIG. 1. For example, UE device 104 includes a controller 304, which is configured to perform the various steps and functions disclosed herein in conjunction with the other components of UE device 104.

The UE device 104 further includes a wireless transmitter 306 configured to transmit wireless signals to base station 102 and TWAN 106. The wireless transmitter 306 is further configured to transmit a request for radio resources associated with a first radio network, the request containing a parameter indicating that all or a portion of user data traffic of the mobile wireless communication device is to be handed over from a second radio network. In the example shown in FIG. 1, the first radio network is a 3GPP Radio Access Network, the second radio network is a WLAN, the request for radio resources is a Connectivity Request message, and the parameter indicating that all or a portion of user data traffic of the UE device is to be handed over from a second radio network is a Request Type parameter (e.g., Information Element).

The UE device 104 additionally includes a wireless receiver 308 configured to receive wireless signals from base station 102 and TWAN 106. The wireless receiver 306 is further configured to receive a control message establishing the requested radio resources. Although FIG. 3 depicts UE device 104 as having a separate transmitter 306 and receiver 308, a transceiver could be used in place of transmitter 306 and receiver 308. Similarly, although transmitter 306 and receiver 308 are shown as both having their own antenna, UE device 104 may be modified to have different antenna configurations that include a greater number or a smaller number of antennas that may be used to transmit and/or receive wireless signals.

Regardless of the exact configuration of UE device 104, the UE device 104 includes electronics and code for communicating with base stations, WLAN access points, and with other wireless communication devices in device-to-device (D2D) configurations. The wireless communication device can include devices such as cell phones, smartphones, tablets, wireless modem cards, wireless modems, televisions with wireless communication electronics, and laptop and desktop computers, as well as other devices. The combination of wireless communication electronics with an electronic device, therefore, may form a wireless communication device 104. For example, a wireless communication device may include a wireless modem connected to an appliance, computer, television, or pool controller.

Although only one UE device is shown in FIG. 1, more than one UE device may be attached to the eNB 102 and/or the TWAN 106. Also, one or more of the UE devices may be within or adjacent to the respective geographical service areas (not shown) of the eNB 102 and the TWAN 106. As the various UE devices move over time, the current values of the various network-related parameters (e.g., signal strength, channel utilization, available bandwidth, etc.) may change, which, in turn, may change which network should provide service to the UE devices.

When the current measured values of the network-related parameters change relative to the relevant threshold values, user data traffic of the UE devices may be handed over from one network to another. For example, a comparison of the current values of the network-related parameters to the relevant threshold values may dictate that user data traffic of a UE device be handed over from TWAN 106 to eNB 102. When such a handover is to occur, eNB 102 is given an indication that user data traffic of the UE device is being handed over from TWAN 106.

Although system 100 is shown to provide an indication to eNB 102 regarding which user data traffic of a UE device is to be handed over from a non-3GPP network (e.g., TWAN 106) in accordance with the LTE specifications, the system 100 can be modified so that the indication can be provided to eNB 102 regarding which user data traffic of a UE device is to be handed over from any other additional neighboring radio networks (e.g., a WLAN other than TWAN 106). More specifically, the indication could be modified to identify one specific network from which the user data traffic of a UE device is to be handed over when there are multiple neighboring radio networks. Alternatively, the indication could merely inform the eNB that the user data traffic of a UE device is to be handed over from one of the multiple neighboring radio networks without specifically identifying the specific network from which the UE device was handed over.

Regardless of the technique utilized to provide an indication to the eNB 102 regarding which user data traffic of a UE device is to be handed over from the TWAN 106, the eNB 102 determines, based on the indication, one or more threshold values to send to the UE devices in communication with the eNB 102 so the UE devices can determine whether to route their data traffic over the 3GPP RAN or the WLAN. More specifically, controller 204 of eNB 102 is configured to determine, based at least partially on the indication, at least one network-related parameter threshold value to send to the UE devices.

In system 100, eNB 102 provides the threshold values to UE device 104. For example, transmitter 206 of eNB 102 is configured to transmit the at least one network-related parameter threshold value to one or more UE devices. In cases in which there are multiple UE devices being served by eNB 102, eNB 102 can selectively broadcast/unicast the threshold values to (1) all of the UE devices being served by eNB 102, (2) more than one, but less than all, of the UE devices being served by eNB 102, (3) UE devices that have had user data traffic handed over from any other network, (4) UE devices that have had user data traffic handed over from another, specifically-identified network (e.g., TWAN 106), (5) UE devices that have not had user data traffic handed over from another network, or (6) any combination of the foregoing options.

In system 100, eNB 102 provides the same threshold values to all of the UE devices being served by eNB 102. However, system 100 can be modified so that eNB 102 provides one or more of the UE devices with different threshold values to use in making steering decisions. For example, UE devices that have had user data traffic handed over from TWAN 106 may have different threshold levels for being steered back to TWAN 106 than UE devices that did not have user data traffic handed over from TWAN 106. By providing differentiated threshold levels, eNB 102 has a greater degree of control in affecting the steering decisions made by the UE devices being served by eNB 102.

Regardless of which thresholds have been provided to the various UE devices being served by eNB 102, UE device 104 selects one of the first radio network (e.g., 3GPP RAN) and the second radio network (e.g., TWAN 106) to use to transmit data traffic, based on a comparison between the at least one threshold value received from eNB 102 and one or more current values of various network-related parameters described above. In the example shown in FIG. 3, the receiver 308 of UE device 104 is configured to receive at least one network-related parameter threshold value from the base station 102, and the controller 304 is configured to compare at least one network-related parameter threshold value and a current network-related parameter value and steer user data traffic to the first radio network (e.g., 3GPP RAN) or to the second radio network (e.g., TWAN 106) based at least partially on the comparison.

FIG. 4 is a message diagram for the example where the base station 102 of a first radio network (e.g., 3GPP RAN) (1) receives an indication that resources to be set up for user data traffic of user equipment device 104 are being handed over from a second radio network (e.g., TWAN 106), and (2) sets up radio resources for the user equipment device 104. More specifically, FIG. 4 illustrates the signaling sequence when a UE device requests the use of an existing PDN connection upon handover of user data traffic from a non-3GPP network (e.g., TWAN 106). This UE Requested PDN procedure begins with UE device 104 transmitting a Packet Data Network (PDN) Connectivity Request message 402 to Mobility Management Entity (MME) 108. The PDN Connectivity Request message 402 includes a “Request Type” information element (IE) that is set to “HANDOVER” when the UE device 104 is handing over all or a portion of its user data traffic from a non-3GPP access (e.g., TWAN 106).

In the 3GPP specifications, the purpose of the “Request Type” IE is to indicate whether the UE requests to establish a new connectivity to a PDN or keep the connection to which it has connected via non-3GPP access. In this case, the same PDN connection is used whether the radio access technology is WLAN or 3GPP RAN, and a portion or all of the user data traffic for the existing PDN connection of UE device 104 is to be handed over from WLAN to 3GPP RAN.

Upon receiving the PDN Connectivity Request message 402, the MME 108 allocates a Bearer Identification (ID) and sends a Create Session Request message 404 to the Serving Gateway (GW) 110. A “HANDOVER INDICATION” IE is included in the Create Session Request message 404 if the “Request Type” IE of the PDN Connectivity Request message 402 is set to “HANDOVER.” Upon receiving the Create Session Request message 404 from the MME 108, Serving Gateway 110 forwards the Create Session Request message 404 on to the PDN Gateway (P-GW) 112.

In response to the Create Session Request message 404, the P-GW 112 sends a Create Session Response message 406 to the Serving GW 110. The Serving GW 110 forwards the Create Session Response message 406 to the MME 108.

Upon receiving the Create Session Response message 406, the MME 108 sends an Evolved UMTS Terrestrial Radio Access Network (E-UTRAN) Radio Access Bearer (E-RAB) Setup Request message 408 to the eNB 102 in order to set up the radio resources that are required to grant the PDN Connectivity Request 402 that was sent by the UE device 104. The E-RAB Setup Request message 408 includes a PDN Connectivity Accept message to be forwarded to the UE device 104. The E-RAB Setup Request message 408 also includes a “HANDOVER INDICATION” parameter if the “Request Type” IE of the PDN Connectivity Request message 402 was set to “HANDOVER” in accordance with an embodiment of the invention.

The eNB 102 sends a Radio Resource Control (RRC) Connection Reconfiguration message 410 to the UE device 104 to establish the radio resources required to grant the PDN Connectivity Request 402 that was sent by the UE device 104. The RRC Connection Reconfiguration message 410 includes the PDN Connectivity Accept message from the MME 108. Upon completion of the RRC Connection Reconfiguration, the UE device 104 sends an RRC Connection Reconfiguration Complete message 412 to the eNB 102. After receiving the RRC Connection Reconfiguration Complete message 412, the eNB 102 sends an E-RAB Setup Response message 414 to the MME 108.

The UE device 104 also sends a PDN Connectivity Complete message 416 to the eNB 102, which forwards the PDN Connectivity Complete message 416 to the MME 108. Upon receiving the PDN Connectivity Complete message 416, the MME 108 sends a Modify Bearer Request message 418 to the Serving GW 110. The Serving GW 110 forwards the Modify Bearer Request message 418 on to the P-GW 112. In response to the Modify Bearer Request message 418, the P-GW 112 sends a Modify Bearer Response message 420 to the Serving GW 110, which forwards the Modify Bearer Response message 420 to the MME 108.

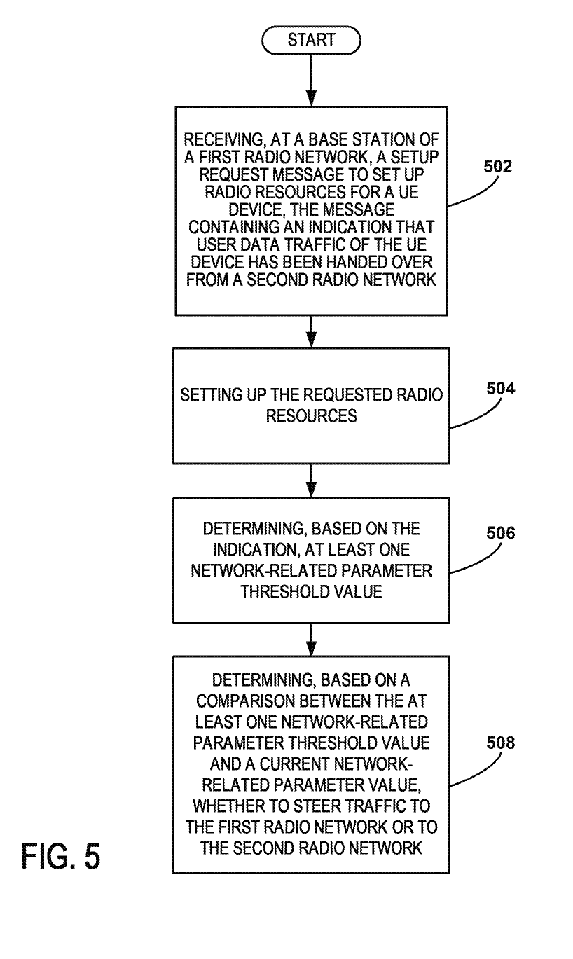

FIG. 5 is a flowchart of an example of a method of utilizing the communication system of FIG. 1 to provide an indication to an eNB of a first radio network that all or a portion of user data traffic of a UE device is to be handed over from a second radio network. The method begins at step 502, where a base station 102 of a first radio network (e.g., 3GPP RAN) receives a setup request message 408 requesting that the base station 102 set up radio resources for a user equipment (UE) device 104, the setup request message 408 containing an indication that all or a portion of user data traffic of the UE device has been handed over from a second radio network (e.g., TWAN 106).

In the example of FIG. 5, the first radio network is a 3GPP Radio Access Network, the second radio network is a WLAN, and the setup request message 408 is transmitted from a Mobility Management Entity 108. In this scenario, the indication that all or a portion of user data traffic of the UE device 104 is to be handed over from a second radio network is based at least partially on a Request Type parameter (e.g., Information Element) received from the UE device 104 in a Connectivity Request message 402.

However, the method could be modified so that the first radio network is a network other than a 3GPP RAN and that the second radio network is a network other than a WLAN. Additionally, the method could be modified so that the setup request message is sent from an entity other than the MME. For example, the setup request message could be sent from (1) an entity other than the MME within the 3GPP RAN, (2) a different entity within a non-3GPP RAN, (3) an entity within the second radio network (e.g., WLAN), or (4) the UE device, itself.

At step 504, the base station 102 sets up the requested radio resources. At step 506, the base station determines at least one network-related parameter threshold value, based at least partially on the indication that all or a portion of user data traffic of the UE device 104 has been handed over from the second radio network. Although not explicitly shown in FIG. 5, base station 102 transmits the at least one network-related parameter threshold value to the UE device 104. At step 508, the UE device 104 determines whether to steer traffic to the first radio network or to the second radio network, based at least partially on a comparison between the at least one network-related parameter threshold value and a current network-related parameter value.

Although various combinations of steps have been described in connection with the method shown in FIG. 5, any of the steps disclosed herein may be added to or deleted from any particular combination of steps shown in the method of FIG. 5.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A method comprising:
receiving, at a base station of a first radio network, a setup request message requesting that the base station set up radio resources for a user equipment (UE) device, the setup request message containing an indication that user data traffic of the UE device is to be handed over from a second radio network; and
setting up the requested radio resources for the UE device.

2. The method of claim 1, wherein the first radio network is a 3GPP Radio Access Network, and the setup request message is transmitted from a Mobility Management Entity.

3. The method of claim 2, wherein the indication is based at least partially on a Request Type parameter received from the UE device in a Connectivity Request message.

4. The method of claim 1, wherein the second radio network is a Wireless Local Area Network.

5. The method of claim 1, further comprising:
determining, based at least partially on the indication, at least one network-related parameter threshold value.

6. The method of claim 5, further comprising:
determining, based at least partially on a comparison between the at least one network-related parameter threshold value and a current network-related parameter value, whether to steer traffic to the first radio network or to the second radio network.

7. A mobile wireless communication device, comprising:
a transmitter configured to transmit a request for radio resources associated with a first radio network, the request containing a parameter indicating that user data traffic of the mobile wireless communication device is to be handed over from a second radio network; and
a receiver configured to receive a control message establishing the requested radio resources.

8. The mobile wireless communication device of claim 7, wherein the first radio network is a 3GPP Radio Access Network, the request for radio resources is a Connectivity Request message, and the parameter is a Request Type parameter.

9. The mobile wireless communication device of claim 7, wherein the second radio network is a Wireless Local Area Network.

10. The mobile wireless communication device of claim 7, further comprising:
a controller configured to
compare at least one network-related parameter threshold value and a current network-related parameter value, and
based at least partially on the comparison, steer traffic to the first radio network or to the second radio network.

11. The mobile wireless communication device of claim 10, wherein the receiver is configured to receive the at least one network-related parameter threshold value from a base station.

12. A base station of a first radio network, the base station comprising:
a receiver configured to receive a setup request message requesting that the base station set up radio resources for a user equipment (UE) device, the setup request message containing an indication that user data traffic of the UE device is to be handed over from a second radio network; and
a transmitter configured to transmit a control message establishing the requested radio resources.

13. The base station of claim 12, wherein the first radio network is a 3GPP Radio Access Network, and the setup request message is received from a Mobility Management Entity.

14. The base station of claim 13, wherein the indication is based at least partially on a Request Type parameter received from the UE device in a Connectivity Request message.

15. The base station of claim 12, wherein the second radio network is a Wireless Local Area Network.

16. The base station of claim 12, further comprising:
a controller configured to determine, based at least partially on the indication, at least one network-related parameter threshold value.

17. The base station of claim 16, wherein the transmitter is configured to transmit the at least one network-related parameter threshold value.
